(19) United States
(12) Patent Application Publication
(10) Pub. No.: US 2026/0138921 A1
(43) Pub. Date: May 21, 2026

(54) Concrete Admixtures

(71) Applicant: FOSROC INTERNATIONAL LIMITED, Tamworth Staffordshire (GB)

(72) Inventors: Justin (Byung Gi) KIM, Seocho-Gu, Seoul (KR); Madhav G INAMDAR, Karnataka (IN)

(21) Appl. No.: 18/878,385

(22) PCT Filed: Jun. 26, 2023
(86) PCT No.: PCT/GB2023/051668

§ 371 Date: Dec. 23, 2024

(30) Foreign Application Priority Data
Jun. 29, 2022 (GB) 2209548.3

(51) Int. Cl. C04B 22/14; C04B 24/06; C04B 24/10; C04B 24/18; C04B 28/04; C04B 40/00; C04B 103/30

(52) U.S. Cl. CPC C04B 22/14; C04B 24/06; C04B 24/10; C04B 24/18; C04B 28/04; C04B 40/0039; C04B 2103/302

(57) ABSTRACT

The invention provides the use of a modified saccharide as a water-reducing additive for concrete, wherein the modified saccharide is selected from glucose syrup, high maltose corn syrup, high fructose corn syrup, dextrins, sugar alcohols and combinations thereof. The modified saccharide is used together with one or more supplemental active agent comprising a metabisulphite salt, optionally in combination with a gluconate. The modified saccharide makes up 50 wt % or more of the active agents used as water-reducing additives.

### FIELD OF THE INVENTION

The present invention relates to admixtures for use in concrete.

### BACKGROUND TO THE INVENTION

Concrete is a construction material formed from a mixture of cement, aggregates (sand and stone) and water. The water used in concrete activates the cement, which acts as the binding agent (binder). The aggregates (coarse and fine) in the mix are bound together by the cement as it sets and cures to produce a hardened concrete. Mixes that use larger aggregates tend to be stronger than those with finer aggregates. Importantly, the less water that is added to a concrete mixture, the stronger that mixture will be.

The cement may commonly be hydraulic cement, such as Portland cement. Portland cement (also known as Ordinary Portland Cement or OPC) may be defined as a cementitious material meeting the requirements of ASTM C150 or the requirements of European Standard EN197-1.

Portland cement is prepared by heating a mixture of raw components (including calcium carbonate, aluminium silicate, silicon dioxide and miscellaneous iron oxides) to a sintering temperature (usually about 1450° C.), resulting in the formation of clinker.

Portland cement clinker is formed by the reaction of calcium oxide with acidic components to give primarily tricalcium silicate, dicalcium silicate, tricalcium aluminate, and a ferrite phase “C4AF” (tetracalcium aluminoferrite).

This clinker is ground with calcium sulphate (usually in the form of gypsum) in a grinding mill to provide the cement in the form of a fine, homogeneous powder. Other additives or cement replacements can be incorporated before or after the milling process. These include fillers and OPC replacements, such as calcium carbonate and other minerals, ground granulated blast furnace slag, natural pozzolans and pulverised fuel ash (PFA). The components that form the cement powder (clinker, calcium sulphate, and optional additives such as fillers and cement replacements) may be referred to as the cement composition.

The strength of concrete is important, because it is used to make articles that need to have this property. For example, roads, pavements, bridges, walls, buildings and foundations are often made from concrete.

Concrete admixtures are commonly added during mixing of the cement, aggregates and water, to enhance specific properties of the fresh or hardened concrete, e.g. workability, durability, or early and/or final strength.

Concrete admixtures may include one or more water-reducing agent. Water-reducing agents are additives that can reduce the amount of water that needs to be used for mixing, and that can increase the strength of concrete without adversely impacting concrete workability. A concrete admixture that includes one or more water-reducing agent may be referenced as a water-reducing concrete admixture.

Conventionally, sulfonated melamine resin salts, polycarboxylates, salts of highly condensed naphthalene sulfonic acid formaldehyde, lignin sulfonates (lignosulfonates) and the like have been used as water reducing agents.

The aim of the present invention is to provide alternatives to lignosulphonate-based admixtures, whereby said alternatives are more cost-effective but possess a water-reducing capability equal to or greater than that of lignosulphonate admixtures.

### SUMMARY OF THE INVENTION

The present invention provides, in a first aspect, the use of a modified saccharide as a water-reducing additive for concrete, wherein the modified saccharide is selected from glucose syrup, high maltose corn syrup, high fructose corn syrup, dextrins, sugar alcohols and combinations thereof, and wherein the modified saccharide is used together with one or more supplemental active agent comprising a metabisulphite salt, optionally in combination with a gluconate, and wherein said modified saccharide makes up 50 wt % or more of the active agents used as water-reducing additives.

Significantly, it has been identified by the inventors that each of the above modified saccharides can be effectively and successfully used in combination with a metabisulphite salt, and optionally also with a gluconate, to replace lignosulfonate material in a water-reducing concrete admixture. This is surprising and beneficial.

Being able to use less lignosulfonate material has the technical benefit of providing a cheaper water-reducing concrete admixture whilst still achieving good results.

In general, the modified saccharide may be used to partly or fully replace lignosulfonate material in a concrete admixture. The modified saccharide may therefore be referred to as a lignosulfonate-replacement agent. As discussed above, lignosulfonate material, such as calcium lignosulfonate or sodium lignosulfonate, is commonly used as a water-reducing additive for concrete. When there is partial replacement, there is at least as much, and preferably more, lignosulfonate-replacement agent than lignosulfonate material.

In addition, the use of the modified saccharide as a water-reducing additive for concrete, according to the invention, can achieve improved slump retention.

Thus, in one embodiment the present invention provides the use of a modified saccharide selected from glucose syrup, high maltose corn syrup, high fructose corn syrup, dextrins, sugar alcohols, and combinations thereof, as a water-reducing additive for concrete, whereby the concrete has improved slump retention. The slump retention for the concrete may be improved as compared to a concrete obtained using lignosulfonate material (e.g. calcium lignosulfonate) as the water-reducing additive.

In general, the present invention has provided new options for reducing the amount of water used for mixing. These new options can increase the strength of concrete without adversely impacting concrete workability. These new options can also improve the slump retention.

These new options involve the use of a modified saccharide material which is selected from: glucose syrup, high maltose corn syrup, high fructose corn syrup, dextrins, sugar alcohols, and combinations thereof.

These modified saccharide materials are known in the art and are available commercially.

Glucose syrup is widely commercially available and is made from the hydrolysis of starch (e.g. corn, potatoes, wheat, barley, rice or cassava) to obtain a concentrated solution of dextrose, maltose and higher saccharides. Acid hydrolysis and/or enzyme hydrolysis may be used in preparing glucose syrup.

Standard corn syrup is a sugar syrup comprising glucose, maltose and higher oligosaccharides. It is prepared from corn starch and is commercially available in a range of grades with different amounts of these sugars. Standard corn syrup can then be enzymatically treated to obtain high maltose corn syrup or high fructose corn syrup.

In the context of this invention a high maltose corn syrup has 40 wt % or more maltose content, such as from 45 to 55 wt % maltose. It is known in the art that levels of maltose of 40-55 wt % or more, such as 50-55 wt % or more, and even as high as 70-80 wt % or more, can be produced by enzyme treatment of corn syrup, e.g. using β-amylase or a combination of pullulanase and D-amylase.

In the context of this invention a high fructose corn syrup has 40 wt % or more fructose content, such as from 42 to 55 wt % fructose. It is known in the art that levels of fructose of 40-55 wt % or more, such as 42-55 wt % or more, can be produced by enzyme treatment of corn syrup, e.g. using glucose isomerase or D-xylose isomerase, to convert some of the glucose to fructose.

In one embodiment, the high fructose corn syrup used in the present invention comprises 40 to 65 wt % fructose, such as 40 to 60 wt % fructose and especially 40 to 55 wt % fructose. In one embodiment, the high fructose corn syrup used in the present invention comprises 42 wt % or more fructose, such as from 42 to 65 wt % fructose, or from 42 to 60 wt % fructose, or from 42 to 55 wt % fructose.

The balance of the high fructose corn syrup, i.e. the components that are not fructose, may be substantially made up of water, glucose and glucose oligomers.

In one embodiment, the high maltose corn syrup used in the present invention comprises 40 to 80 wt % maltose, such as 40 to 65 wt % maltose and especially 40 to 55 wt % maltose.

In one embodiment, the high maltose corn syrup used in the present invention comprises 45 wt % or more maltose, such as from 45 to 65 wt % maltose, or from 45 to 55 wt % maltose, or from 45 to 50 wt % maltose.

The high maltose corn syrup used in the present invention may comprise maltotriose, such as 20 wt % or more, or 22 wt % or more, or 24 wt % or more maltotriose. In a preferred embodiment, the high maltose corn syrup used in the present invention comprises 40 wt % or more maltose and 20 wt % or more maltotriose, such as 45 wt % or more maltose and 24 wt % or more maltotriose. It may be that the corn syrup comprises 40-65 wt % maltose and 20-35 wt % maltotriose, such as 40-55 wt % maltose and 20-30 wt % maltotriose, or 45-50 wt % maltose and 24-30 wt % maltotriose.

The balance of the high maltose corn syrup, i.e. the components that are not maltose and maltotriose, may be substantially made up of water, dextrose and higher saccharides.

Dextrins are low-molecular-weight polymeric carbohydrates formed from the hydrolysis of starch (e.g. potato, corn, rice or wheat). Dextrins are mixtures of polymers of d-glucose units linked by α-(1→4) or α-(1→6) glycosidic bonds. Types of dextrins include white dextrins, yellow dextrins, British gums and maltodextrins. White dextrins are made by heating the starch at a relatively low temperature in the presence of an acid.

Yellow dextrins are made by heating the starch to relatively high temperatures in the presence of an acid. British gums are made by heating the starch at a relatively high temperature in the presence of an alkali. Maltodextrins are made by partial hydrolysis of starch (e.g. corn or wheat); controlled enzyme or acid partial hydrolysis may be used. Dextrins are also widely commercially available.

In one embodiment, the dextrin is white dextrin or yellow dextrin. The dextrin may, for example, be derived from potato starch or from corn starch. In one embodiment, dextrin derived from corn starch is preferred.

Sugar alcohols have the general formula HOCH₂(CHOH)ₙCH₂OH, where n is zero or an integer from 1 to 22, preferably from 1 to 10, e.g. from 2 to 5. In one embodiment, n may be 1, 2, 3 or 4. It can be seen from this formula that sugar alcohols have one—OH group attached to each carbon in the chain. Many sugar alcohols have n=3 or 4, i.e. they have chains with five or six carbon atoms, due to being derived from pentoses or hexoses. Sugar alcohols are also widely commercially available. Examples of sugar alcohols are ethylene glycol, glycerol, sorbitol, mannitol, xylitol and maltitol.

Combinations of two or more sugar alcohols can also be contemplated. In one preferred embodiment, the sugar alcohol is selected from sorbitol, mannitol, xylitol and combinations thereof. It may, in particular, be that the sugar alcohol is sorbitol and/or mannitol.

The skilled person will appreciate that, provided there are no compatibility issues, more than one of these modified saccharide materials can be used together in combination, but it is not necessary to use more than one. In one embodiment, only one of these modified saccharide materials is used. In another embodiment, a combination of two or more of these modified saccharide materials is used.

In one embodiment, glucose syrup and/or high fructose corn syrup and/or high maltose corn syrup is used. In one embodiment, glucose syrup and/or high fructose corn syrup is used.

In one embodiment, glucose syrup and/or high fructose corn syrup and/or high maltose corn syrup is used as the majority modified saccharide material and yellow dextrin is additionally used as a minority modified saccharide material. In one embodiment, glucose syrup and/or high fructose corn syrup is used as the majority modified saccharide material and yellow dextrin is additionally used as a minority modified saccharide material.

The present invention also provides, in a second aspect, a water-reducing concrete admixture comprising:
a) a modified saccharide selected from glucose syrup, high maltose corn syrup, high fructose corn syrup, dextrins, sugar alcohols and combinations thereof; and
b) one or more supplemental active agent comprising a metabisulphite salt, optionally in combination with a gluconate;

wherein no active agent is present in the admixture in a greater amount (by weight) than the modified saccharide.

This admixture has the benefit that no lignosulfonate material needs to be present in order to achieve good results and the admixture is more cost-effective than lignosulfonate-based admixtures.

A further benefit of using the water-reducing concrete admixture of the second aspect is that the slump retention for the concrete may be improved as compared to a concrete obtained using lignosulfonate material (e.g. calcium lignosulfonate) as the water-reducing additive.

The metabisulphite salt is suitably inorganic and may preferably be an alkali metal salt or an alkaline earth metal salt, for example a potassium, calcium or sodium salt. In a preferred embodiment the metabisulfite salt is sodium metabisulfite or calcium metabisulfite, especially sodium metabisulfite (SMBS).

The gluconate, when present, is preferably an alkali metal gluconate or an alkaline earth metal gluconate, for example potassium, calcium or sodium gluconate. In a preferred embodiment the gluconate is sodium gluconate.

In one embodiment, the water-reducing concrete admixture comprises both a metabisulphite salt and a gluconate, e.g. sodium metabisulfite and sodium gluconate.

The skilled person will appreciate that these materials can each be provided as a solution or as a powder.

A benefit of the present invention is that the modified saccharide selected from glucose syrup, high maltose corn syrup, high fructose corn syrup, dextrins, sugar alcohols and combinations thereof can be effectively and successfully used to partly or fully replace lignosulfonate material in a water-reducing concrete admixture.

It may be that the admixture is intended as a full lignosulfonate replacement. In such an embodiment, the water-reducing concrete admixture of the second aspect may, for example, comprise no more than 2 wt % lignosulfonate material, such as no more than 1 wt % lignosulfonate material; and in one embodiment the admixture includes no lignosulfonate material.

It may alternatively be that the admixture is intended as partial lignosulfonate replacement. In such an embodiment, the water-reducing concrete admixture of the second aspect comprises:
a) a modified saccharide selected from glucose syrup, high maltose corn syrup, high fructose corn syrup, dextrins, sugar alcohols, and combinations thereof;
b) one or more supplemental active agent comprising a metabisulphite salt, optionally in combination with a gluconate; and
c) lignosulfonate material;

wherein no active agent is present in the admixture in a greater amount (by weight) than the modified saccharide.

In this regard, the modified saccharide is acting as a lignosulfonate-replacement agent.

Thus there should be at least as much modified saccharide as lignosulfonate material, and preferably there is more modified saccharide than lignosulfonate material.

This admixture has the benefit that less lignosulfonate material can be used, thereby reducing costs, whilst still achieving good results.

The lignosulfonate material may, for example, be selected from sodium lignosulfonate, calcium lignosulfonate, magnesium lignosulfonate, potassium lignosulfonate, and combinations thereof. In one embodiment, the lignosulfonate material comprises or is calcium lignosulfonate.

In the admixture of the invention, no other active agent is present in a greater amount than the modified saccharide (selected from glucose syrup, high maltose corn syrup, high fructose corn syrup, dextrins, sugar alcohols and combinations thereof), i.e. it is preferred that it is the majority active agent. In one embodiment, the only component of the composition that is present in a greater amount than the modified saccharide is solvent (e.g. water), which is of course not considered an active agent.

Therefore, the water-reducing concrete admixture according to the invention comprises the modified saccharide (selected from glucose syrup, high maltose corn syrup, high fructose corn syrup, dextrins, sugar alcohols, and combinations thereof) as the majority active agent, meaning that the metabisulphite salt and any other additional active agents that are present (such as lignosulfonate material and/or a gluconate) are each present in lower amounts, by weight, than the amount of the modified saccharide that is selected from glucose syrup, high maltose corn syrup, high fructose corn syrup, dextrins, sugar alcohols and combinations thereof.

The water-reducing concrete admixture according to the invention may comprise the modified saccharide (selected from glucose syrup, high maltose corn syrup, high fructose corn syrup, dextrins, sugar alcohols, and combinations thereof) as at least 50 wt % of the total active agent, and preferably more than 50 wt %. In one embodiment, the modified saccharide makes up 60 wt % or more, or 70 wt % or more, or 75 wt % or more, of the active agent in the water-reducing concrete admixture.

The present invention further provides, in a third aspect, a method of producing concrete, the method comprising:
mixing cement, aggregates and water together with a water-reducing concrete admixture as defined in the second aspect.

In one embodiment, the water-reducing concrete admixture is added at an addition level (with respect to the total dry weight of binder in the mixture) of from 0.1 to 5 wt %, e.g. from 0.25 to 3 wt %, or from 0.5 to 2 wt %.

The cement (binder) may be hydraulic cement, such as Portland cement.

The method may result in a concrete product that has improved slump retention.

### DETAILED DESCRIPTION OF THE INVENTION

In the present invention a modified saccharide, selected from glucose syrup, high maltose corn syrup, high fructose corn syrup, dextrins, sugar alcohols and combinations thereof, is used as a water-reducing additive for concrete. These materials have been identified as cost-effective replacements for lignosulfonate material and they can replace some or all of the lignosulfonate material used in a water-reducing concrete admixture.

The modified saccharide, selected from glucose syrup, high maltose corn syrup, high fructose corn syrup, dextrins, sugar alcohols and combinations thereof, may be referred to herein as lignosulfonate-replacement agent.

The skilled person will appreciate that, provided there are no compatibility issues, more than one of these materials can be used together in combination, but it is not necessary to use more than one. In one embodiment, only one of these modified saccharide materials is used. In another embodiment, a combination of two or more of these modified saccharide materials is used.

In one embodiment, the modified saccharide is glucose syrup, or high maltose corn syrup, or high fructose corn syrup, or white dextrin or yellow dextrin, or combinations thereof. In one embodiment, the modified saccharide is glucose syrup or white dextrin or yellow dextrin, or combinations thereof.

In one embodiment, the dextrin is white dextrin or yellow dextrin that is derived from potato starch or from corn starch. In one embodiment, dextrin derived from corn starch is preferred.

In one embodiment, the modified saccharide is glucose syrup, high maltose corn syrup, high fructose corn syrup or combinations thereof.

In one embodiment, the modified saccharide is glucose syrup, high fructose corn syrup or combinations thereof.

In all aspects of the invention, the lignosulfonate material that is fully or partly replaced may, in particular, be calcium lignosulfonate. However, it could alternatively or additionally be other lignosulfonate material, such as sodium lignosulfonate or magnesium lignosulfonate or potassium lignosulfonate.

### Full Replacement

In one embodiment, there is full replacement of the lignosulfonate material. Thus, a water-reducing concrete admixture comprises modified saccharide, selected from glucose syrup, high maltose corn syrup, high fructose corn syrup, dextrins, sugar alcohols and combinations thereof, and comprises no lignosulfonate material (or substantially no lignosulfonate material, e.g. 2 wt % or less).

The lignosulfonate-replacement agent is used in combination with a supplemental active agent. The supplemental active agent comprises a metabisulphite salt, optionally in combination with a gluconate.

No active agent is present in the admixture in a greater amount than the modified saccharide.

It may be that the water-reducing concrete admixture comprises:
a) one or more lignosulfonate-replacement agent selected from glucose syrup, high maltose corn syrup, high fructose corn syrup, dextrins, sugar alcohols and combinations thereof; and
b) a supplemental active agent which comprises an alkali metal or alkaline earth metal metabisulphite salt; optionally in combination with an alkali metal or alkaline earth metal gluconate.

In one embodiment, the supplemental active agent is selected from: sodium metabisulfite and calcium metabisulfite, optionally in combination with one or more of potassium gluconate, calcium gluconate and sodium gluconate.

In a preferred embodiment the supplemental active agent is sodium metabisulfite, optionally in combination with sodium gluconate.

In one embodiment, the supplemental active agent comprises both metabisulphite salt and gluconate; in one preferred embodiment the metabisulphite salt and gluconate are included in a weight ratio of 0.5:1 or more, especially 0.75:1 or more, preferably 1:1 or more, e.g. 1.1:1 or more, or 1.2:1 or more. Having at least as much metabisulphite salt as gluconate, by weight in the admixture may be beneficial.

In one embodiment, there may be at least twice as much metabisulphite salt as gluconate, by weight in the admixture, e.g. three times as much, or more. In another embodiment, there may be about the same amount as metabisulphite salt as gluconate, by weight in the admixture.

The supplemental active agent is present in the same or lower amounts, by weight, than the amount of the modified saccharide (which is selected from glucose syrup, high maltose corn syrup, high fructose corn syrup, dextrins, sugar alcohols and combinations thereof).

It may therefore be that the weight ratio of lignosulfonate-replacement agent to the total amount of supplemental active agent (e.g. sodium metabisulfite, optionally in combination with sodium gluconate) is from 1:1 to 50:1, such as from 1:1 to 40:1, preferably from 1:1 to 30:1, e.g. it may be from 1:1 to 25:1 or from 1:1 to 20:1 or from 1:1 to 15:1.

In one preferred embodiment it may be that the weight ratio of lignosulfonate-replacement agent to the total amount of supplemental active agent (e.g. sodium metabisulfite, optionally in combination with sodium gluconate) is from 1:1 to 10:1, such as from 1:1 to 7:1, preferably from 1:1 to 5:1 or from 1:1 to 3:1 or from 1:1 to 2:1.

It is preferred that the water-reducing concrete admixture comprises modified saccharide, selected from glucose syrup, high maltose corn syrup, high fructose corn syrup, dextrins, sugar alcohols and combinations thereof, as the majority active agent.

Thus, in one embodiment, the weight ratio of lignosulfonate-replacement agent to the total amount of supplemental active agent (e.g. sodium metabisulfite optionally in combination with sodium gluconate) may be from 1.1:1 to 10:1, such as from 1.1:1 to 7:1, preferably from 1.1:1 to 5:1 or from 1.1:1 to 3:1 or from 1.1:1 to 2:1. It may be that the weight ratio of lignosulfonate-replacement agent to the total amount of supplemental active agent (e.g. sodium metabisulfite optionally in combination with sodium gluconate) is from 1.2:1 to 10:1, such as from 1.2:1 to 7:1, preferably from 1.2:1 to 5:1 or from 1.2:1 to 3:1 or from 1.2:1 to 2:1.

The water-reducing concrete admixture may optionally further comprise a solvent. This may be useful in relation to the ease of addition of the admixture when mixing the concrete. The solvent may, in one embodiment, be water. When solvent is present, it may suitably be present in the water-reducing concrete admixture in amounts of up to 95 wt %, e.g. up to 90 wt % or up to 85 wt %. In one embodiment when solvent is present, it may be present in the water-reducing concrete admixture in amounts of from 5 to 95 wt %, e.g. from 10 to 90 wt % or from 15 to 85 wt %, such as from 20 to 80 wt % or from 25 to 75 wt %.

In one embodiment, the majority of the water-reducing concrete admixture is lignosulfonate-replacement agent and supplemental active agent and optional solvent (e.g. 60 wt % or more, or 70 wt % or more, or 80 wt % or more, such as 90 wt % or more of the water-reducing concrete admixture). In one embodiment it may be that the water-reducing concrete admixture consists essentially of lignosulfonate-replacement agent and supplemental active agent and optional solvent, or it may consist only of lignosulfonate-replacement agent and supplemental active agent and optional solvent.

However, it may optionally be that other additives are present in the water-reducing concrete admixture, e.g. in amounts of 15 wt % or less, such as 10 wt % or less, e.g. from 0.5 to 10 wt % or from 1 to 8 wt %. These other additives may be materials known in the art for use in concrete admixtures, e.g. surfactants (air entraining agents and/or defoamers) and/or amines (known for use as strength enhancers and/or set accelerators) and/or defoamers and/or biocides.

Amines such as triethanolamine, diethanolamine, dimethylethanolamine, tri-isopropanolamine and diethanol isopropanolamine are, in particular, known for use in concrete and may optionally be present.

Specific examples of additives that may be present in the present invention include sodium lauryl ether sulphate, triethanolamine and tri-isopropanolamine. Tri-isobutylphosphate and formaldehyde are also examples of other additives that can, in embodiments, be present.

It may optionally be that melamine and/or sulfonated melamine resin salts are included as additives, e.g. in amounts of 15 wt % or less, such as 10 wt % or less or 5 wt % or less, e.g. from 0.5 to 10 wt % or from 1 to 8 wt %. These are known in the art as water-reducing agents, but in the present invention are used in lower amounts than is conventional.

In one embodiment, the lignosulfonate-replacement agent is glucose syrup, or high maltose corn syrup, or high fructose corn syrup, or white dextrin or yellow dextrin, or combinations thereof. In one embodiment, the lignosulfonate-replacement agent is glucose syrup or white dextrin or yellow dextrin, or combinations thereof. In one embodiment, the lignosulfonate-replacement agent is glucose syrup, or high maltose corn syrup, or high fructose corn syrup. In one embodiment, the lignosulfonate-replacement agent is glucose syrup, or high fructose corn syrup.

### Partial Replacement

In one embodiment, there is only a partial replacement of the lignosulfonate material. Thus, a water-reducing concrete admixture comprises (a) a modified saccharide, selected from glucose syrup, high maltose corn syrup, or high fructose corn syrup, dextrins, sugar alcohols and combinations thereof, (b) a supplemental active agent which comprises a metabisulphite salt, optionally in combination with a gluconate, and (c) lignosulfonate material.

No active agent is present in the admixture in a greater amount (by weight) than the modified saccharide.

Thus when there is partial replacement, there is at least as much, and preferably more, lignosulfonate-replacement agent as compared to lignosulfonate material (by weight).

In one preferred embodiment there is at least twice as much lignosulfonate-replacement agent as lignosulfonate material (by weight), e.g. at least three times as much.

It may be that the weight ratio of lignosulfonate-replacement agent to lignosulfonate material is from 1:1 to 50:1, such as from 1:1 to 40:1, preferably from 1:1 to 30:1, e.g. it may be from 1:1 to 25:1 or from 1:1 to 20:1 or from 1:1 to 15:1. In one preferred embodiment it may be that the weight ratio of lignosulfonate-replacement agent to lignosulfonate material is from 1:1 to 10:1, such as from 1:1 to 7:1, preferably from 1:1 to 5:1.

In one preferred embodiment the weight ratio of lignosulfonate-replacement agent to lignosulfonate material is from 1:1 to 50:1, such as from 1:1 to 10:1 or from 1:1 to 9:1.

In one preferred embodiment the weight ratio of lignosulfonate-replacement agent to lignosulfonate material is from 2:1 to 50:1 or from 2:1 to 30:1 or from 2:1 to 20:1, such as from 2:1 to 10:1 or from 2:1 to 9:1.

In one embodiment the weight ratio of lignosulfonate-replacement agent to lignosulfonate material is from 4:1 to 50:1, such as from 4:1 to 10:1 or from 4:1 to 9:1.

In one embodiment, the supplemental active agent is selected from: sodium metabisulfite and calcium metabisulfite, optionally in combination with one or more of potassium gluconate, calcium gluconate and sodium gluconate.

In a preferred embodiment the supplemental active agent is sodium metabisulfite, optionally in combination with sodium gluconate.

In one embodiment, the supplemental active agent comprises both metabisulphite salt and gluconate; in one preferred embodiment the metabisulphite salt and gluconate are included in a weight ratio of 0.5:1 or more, especially 0.75:1 or more, preferably 1:1 or more, e.g. 1.1:1 or more, or 1.2:1 or more. Having at least as much metabisulphite salt as gluconate, by weight in the admixture may be beneficial.

In one embodiment, there may be at least twice as much metabisulphite salt as gluconate, by weight in the admixture, e.g. three times as much, or more. In another embodiment, there may be about the same amount as metabisulphite salt as gluconate, by weight in the admixture.

The supplemental active agent is present in the same or lower amounts, by weight, than the amount of the modified saccharide (which is selected from glucose syrup, high maltose corn syrup, high fructose corn syrup, dextrins, sugar alcohols and combinations thereof).

It may therefore be that the weight ratio of lignosulfonate-replacement agent to the total amount of supplemental active agent (e.g. sodium metabisulfite, optionally in combination with sodium gluconate) is from 1:1 to 50:1, such as from 1:1 to 40:1, preferably from 1:1 to 30:1, e.g. it may be from 1:1 to 25:1 or from 1:1 to 20:1 or from 1:1 to 15:1.

In one preferred embodiment it may be that the weight ratio of lignosulfonate-replacement agent to the total amount of supplemental active agent (e.g. sodium metabisulfite, optionally in combination with sodium gluconate) is from 1:1 to 10:1, such as from 1:1 to 7:1, preferably from 1:1 to 5:1 or from 1:1 to 3:1 or from 1:1 to 2:1. It is preferred that the water-reducing concrete admixture comprises modified saccharide, selected from glucose syrup, high maltose corn syrup, high fructose corn syrup, dextrins, sugar alcohols and combinations thereof, as the majority active agent.

Thus, in one embodiment, the weight ratio of lignosulfonate-replacement agent to the total amount of supplemental active agent (e.g. sodium metabisulfite optionally in combination with sodium gluconate) may be from 1.1:1 to 10:1, such as from 1.1:1 to 7:1, preferably from 1.1:1 to 5:1 or from 1.1:1 to 3:1 or from 1.1:1 to 2:1. It may be that the weight ratio of lignosulfonate-replacement agent to the total amount of supplemental active agent (e.g. sodium metabisulfite optionally in combination with sodium gluconate) is from 1.2:1 to 10:1, such as from 1.2:1 to 7:1, preferably from 1.2:1 to 5:1 or from 1.2:1 to 3:1 or from 1.2:1 to 2:1.

The water-reducing concrete admixture may optionally further comprise a solvent. This may be useful in relation to the ease of addition of the admixture when mixing the concrete. The solvent may, in one embodiment, be water. When solvent is present, it may suitably be present in the water-reducing concrete admixture in amounts of up to 95 wt %, e.g. up to 90 wt % or up to 85 wt %. In one embodiment when solvent is present, it may be present in the water-reducing concrete admixture in amounts of from 5 to 95 wt %, e.g. from 10 to 90 wt % or from 15 to 85 wt %, such as from 20 to 80 wt % or from 25 to 75 wt %.

In one embodiment, the majority of the water-reducing concrete admixture is lignosulfonate-replacement agent and supplemental active agent and lignosulfonate material and optional solvent (e.g. 60 wt % or more, or 70 wt % or more, or 80 wt % or more, such as 90 wt % or more of the water-reducing concrete admixture). In one embodiment, it may be that the water-reducing concrete admixture consists essentially of lignosulfonate-replacement agent and supplemental active agent and lignosulfonate material and optional solvent, or it may consist only of lignosulfonate-replacement agent and supplemental active agent and lignosulfonate material and optional solvent.

However, it may optionally be that other additives may be present in the water-reducing concrete admixture, e.g. in amounts of 15 wt % or less, such as 10 wt % or less, e.g. from 0.5 to 10 wt % or from 1 to 8 wt %. These other additives may be materials known in the art for use in concrete admixtures, e.g. surfactants (air entraining agents and/or defoamers) and/or amines (known for use as strength enhancers and/or set accelerators) and/or defoamers and/or biocides.

Amines such as triethanolamine, diethanolamine, dimethylethanolamine, tri-isopropanolamine and diethanol isopropanolamine are, in particular, known for use in concrete and may optionally be present.

Specific examples of additives that may be present in the present invention include sodium lauryl ether sulphate, triethanolamine and tri-isopropanolamine. Tri-isobutylphosphate and formaldehyde are also examples of other additives that can, in embodiments, be present.

It may optionally be that melamine and/or sulfonated melamine resin salts are included as additives, e.g. in amounts of 15 wt % or less, such as 10 wt % or less or 5 wt % or less, e.g. from 0.5 to 10 wt % or from 1 to 8 wt %. These are known in the art as water-reducing agents, but in the present invention are used in lower amounts than is conventional.

In one embodiment, the lignosulfonate-replacement agent is glucose syrup, or high maltose corn syrup, or high fructose corn syrup, or white dextrin or yellow dextrin, or combinations thereof. In one embodiment, the lignosulfonate-replacement agent is glucose syrup or white dextrin or yellow dextrin, or combinations thereof. In one embodiment, the lignosulfonate-replacement agent is glucose syrup, or high maltose corn syrup, or high fructose corn syrup. In one embodiment, the lignosulfonate-replacement agent is glucose syrup, or high fructose corn syrup.

### Use of the Admixtures

The admixtures of the present invention may suitably be mixed with cement (binder) at addition levels of from 0.1 to 5 wt %, e.g. from 0.25 to 3 wt %, such as 0.5 to lwt %.

The admixtures of the present invention allow good water-reduction to be achieved and good strength characteristics to be achieved.

The admixtures of the present invention may allow improved slump retention to be achieved. The slump retention for the resulting concrete may be improved as compared to a concrete obtained using lignosulfonate material (e.g. calcium lignosulfonate) as the water-reducing additive.

The invention will now be further illustrated by reference to the following non-limiting worked examples.

### Examples

The materials used in the examples were all obtained from commercial suppliers.

Three different concrete mixes were prepared:

Mix # 1:

| | Quantity |
|---|---|
| Concrete materials | (kg/m³) |
| Cement OPC | 300 |
| Crushed fine aggregate (0.1-4.75 mm) | 836 |
| Coarse aggregate (4.75-10 mm) | 333 |
| Coarse aggregate (10-20 mm) | 776 |
| Water | 153 |
| w/c ratio | 0.51 |

Mix # 2:

| | Quantity |
|---|---|
| Concrete materials | (kg/m³) |
| Cement OPC | 150 |
| GGBS | 150 |
| Crushed fine aggregate (0.1-4.75 mm) | 836 |
| Coarse aggregate (4.75-10 mm) | 333 |
| Coarse aggregate (10-20 mm) | 776 |
| Water | 153 |
| w/c ratio | 0.51 |

Mix # 3:

| | Quantity |
|---|---|
| Concrete materials | (kg/m³) |
| Cement OPC | 280 |
| Crushed fine aggregate (0.1-4.75 mm) | 986 |
| Coarse aggregate (4.75-10 mm) | 247 |
| Coarse aggregate (10-20 mm) | 740 |
| Water | 165 |
| w/c ratio | 0.59 |

In each case the concrete was mixed using fine aggregate and coarse aggregate and cement from commercial suppliers.

Concrete admixture formulations were made by mechanically mixing together the components set out in Table 1 below, at about room temperature (15-35° C.). The amounts given are parts by weight.

TABLE 1
prepared formulations

| | | | | Corn | | | |
|---|---|---|---|---|---|---|---|
| | | | Tri-iso | syrup | | | Sodium |
| | | Calcium | butyl | (high | Glucose | Sodium | meta |
| | Water | lignosulfonate | phosphate | fructose) | syrup | gluconate | bisulphite |
| Control | 59.90 | 40.00 | 0.10 | — | — | — | — |
| F1 | 70.00 | — | — | 20.00 | — | 5.00 | 5.00 |
| F2 | 67.00 | — | — | — | 18.00 | 3.00 | 12.00 |
| F3 | 67.00 | — | — | 20.00 | — | 3.00 | 10.00 |

The high fructose corn syrup was an aqueous solution of saccharides with CAS No 8029-43-4.

The prepared admixtures were then tested as follows: The trial concretes were prepared using a pan type mixer, with 10 dm³ volume mixes being prepared for testing.

The tests carried out were all according to EN standards, in particular:
EN 12350-2: Testing fresh concrete—Part 2: Slump test
EN 12350-6: Testing fresh concrete—Part 6: Density
EN 12350-7: Testing fresh concrete—Part 7: Air content of fresh concrete—Pressure methods
EN 12390-3: Testing hardened concrete—Part 3: Compressive strength of test specimens Each of the admixtures as prepared according to Table 1 achieved good results for water-reduction, concrete strength and slump reduction.

In particular, each admixture according to the invention showed:
similar water reduction compared to the control,
similar or better slump retention compared to the control, and
similar or better compressive strength compared to the control.

Each admixture according to the invention also has the benefit of being cost-effective.

TABLE 2
results
Detailed results are set out below:

| | | Admixture | Slump/ | Slump/ | Slump/ | Fresh wet | 1-day | 3-day | 7-day | 28-day |
|---|---|---|---|---|---|---|---|---|---|---|
| Admixture | Concrete | addition | Flow | Flow 30 | Flow 60 | density | strength | strength | strength | strength |
| blend | mix | % | Initial | minutes | minutes | kg/m³ | MPa | MPa | MPa | MPa |
| Control | 1 | 0.50 | 175 | 50 | — | 2446 | 7.31 | 15.25 | 23.03 | 34.66 |
| F1 | 1 | 0.50 | 180 | 90 | 70 | 2452 | 7.66 | 17.43 | 24.18 | 35.87 |
| Control | 2 | 0.50 | 190 | 70 | — | 2429 | 3.26 | 10.05 | 18.11 | 28.66 |
| F1 | 2 | 0.50 | 180 | 90 | 70 | 2427 | 2.83 | 10.47 | 18.44 | 32.59 |
| Control | 3 | 1.00 | 200 | 120 | 80 | 2439 | 5.26 | 20.00 | 22.70 | 29.30 |
| F2 | 3 | 1.00 | 205 | 185 | 135 | 2443 | 1.43 | 18.40 | 21.40 | 28.00 |
| F3 | 3 | 1.00 | 190 | 125 | 100 | 2440 | 4.80 | 19.29 | 23.60 | 29.00 |

### CONCLUSION

The admixtures according to the invention were all able to achieve water-reduction and strength characteristics comparable with or better than a calcium lignosulfonate reference.

In addition, admixtures according to the invention were all able to achieve slump reduction characteristics comparable with or better than a calcium lignosulfonate reference.

Therefore, the admixtures according to the invention provide cost-effective alternatives to the currently used calcium lignosulfonate-based admixtures.

1. The use of a modified saccharide as a water-reducing additive for concrete, wherein the modified saccharide is selected from glucose syrup, high maltose corn syrup, high fructose corn syrup, dextrins, sugar alcohols and combinations thereof, and wherein the modified saccharide is used together with a supplemental active agent comprising a metabisulphite salt, optionally in combination with a gluconate, and wherein said modified saccharide makes up 50 wt % or more of the active agents used as water-reducing additives.

2. The use according to claim 1, wherein said modified saccharide is used to fully replace lignosulfonate material in a concrete admixture or to partially replace lignosulfonate material in a concrete admixture.

3. The use according to claim 1 or claim 2, wherein said modified saccharide is used to improve the slump retention of the concrete.

4. The use according to any one of claims 1-3, wherein said modified saccharide makes up more than 50 wt % of the active agents used as water-reducing additives.

5. The use according to any one of claims 1-4, wherein said modified saccharide is used together with a supplemental active agent comprising a metabisulphite salt and a gluconate.

6. A water-reducing concrete admixture comprising:
a) a modified saccharide selected from glucose syrup, high maltose corn syrup, high fructose corn syrup, dextrins, sugar alcohols and combinations thereof; and
b) a supplemental active agent comprising a metabisulphite salt, optionally in combination with a gluconate;
wherein no active agent is present in the admixture in a greater amount, by weight, than the modified saccharide.

7. The admixture of claim 6, wherein the modified saccharide makes up 50 wt % or more, or 60 wt % or more, or 70 wt % or more, or 75 wt % or more, of the active agent in the water-reducing concrete admixture.

8. The use or the admixture of any one of claims 1-7, wherein the supplemental active agent is selected from: an alkali metal or alkaline earth metal metabisulphite salt, optionally in combination with an alkali metal or alkaline earth metal gluconate.

9. The use or the admixture of claim 8, wherein the supplemental active agent is selected from: sodium metabisulfite and calcium metabisulfite, optionally in combination with potassium gluconate, calcium gluconate or sodium gluconate.

10. The use or the admixture of claim 9, wherein the supplemental active agent is sodium metabisulfite, optionally in combination with sodium gluconate.

11. The use or the admixture of any one of claims 1-10, wherein the supplemental active agent comprises both metabisulphite salt and gluconate.

12. The use or the admixture of claim 11, wherein the metabisulphite salt and gluconate are included in a weight ratio of metabisulphite salt:gluconate of 0.5:1 or more, or 1:1 or more, or 1.1:1 or more, or 1.2:1 or more.

13. The use or the admixture of any one of claims 1-12, wherein the weight ratio of the modified saccharide to the supplemental active agent is from 1:1 to 50:1, or from 1:1 to 25:1, or from 1:1 to 15:1, or from 1:1 to 5:1.

14. The use or the admixture of any one of claims 1-13, wherein the weight ratio of the modified saccharide to the supplemental active agent is from 1.1:1 to 10:1, or from 1.1:1 to 7:1, or from 1.1:1 to 5:1.

15. The use or the admixture of any one of claims 1-14, wherein there is no lignosulfonate material present.

16. The use or the admixture of any one of claims 1-14, wherein there is lignosulfonate material present, with there being at least as much modified saccharide as lignosulfonate material, and preferably more modified saccharide than lignosulfonate material.

17. The use or the admixture of claim 16, wherein the weight ratio of modified saccharide to lignosulfonate material is (a) from 1:1 to 50:1, or (b) from 1:1 to 10:1, or (c) from 1:1 to 9:1, or (d) from 2:1 to 50:1, or (e) from 2:1 to 10:1, or (f) from 2:1 to 9:1.

18. The use or the admixture of claim 16 or claim 17, wherein the lignosulfonate material is selected from sodium lignosulfonate, calcium lignosulfonate, magnesium lignosulfonate, potassium lignosulfonate, and combinations thereof.

19. The admixture of any one of claims 6-18, wherein the admixture further comprises a solvent.

20. The admixture of claim 19, wherein the solvent comprises water.

21. The admixture of claim 19 or claim 20, wherein the admixture comprises solvent in an amount from 5 to 95 wt %, or from 15 to 85 wt %, or from 25 to 75 wt %.

22. The use or the admixture of any one of the preceding claims, wherein the modified saccharide is selected from glucose syrup, high maltose corn syrup, high fructose corn syrup, dextrins, sugar alcohols of formula HOCH₂(CHOH)ₙCH₂OH, where n is zero or an integer from 1 to 22, and combinations thereof.

23. The use or the admixture of claim 22, wherein the modified saccharide is selected from glucose syrup, high maltose corn syrup, high fructose corn syrup, white dextrin, yellow dextrin, sugar alcohols of formula HOCH₂(CHOH)ₙCH₂OH, where n is zero or an integer from 1 to 10, and combinations thereof.

24. The use or the admixture of claim 23, wherein the modified saccharide is selected from (a) glucose syrup, high maltose corn syrup, high fructose corn syrup, and combinations thereof; or (b) glucose syrup, high fructose corn syrup, and combinations thereof.

25. A method of producing concrete, the method comprising:
mixing cement, aggregates and water together with a water-reducing concrete admixture as defined in any one of claims 6-24.

26. The method according to claim 25, wherein the water-reducing concrete admixture is added at an addition level of from 0.1 to 5 wt %.
